(19) United States
(12) Patent Application Publication
(10) Pub. No.: US 2016/0245743 A1
(43) Pub. Date: Aug. 25, 2016

(54) TESTING APPARATUS AND TESTING METHOD

(71) Applicant: SCREEN Holdings Co., Ltd., Kyoto (JP)

(72) Inventor: Minoru MIZUBATA, Kyoto-shi (JP)

(21) Appl. No.: 15/009,982

(22) Filed: Jan. 29, 2016

(30) Foreign Application Priority Data
Feb. 19, 2015 (JP) 2015-030257

(51) Int. Cl. G01N 21/3581; G01N 21/3563

(52) U.S. Cl. CPC G01N 21/3581; G01N 21/3563

(57) ABSTRACT

A testing apparatus is to test a solar cell. A movable stage has a holding surface on which the solar cell is held. A pump light irradiating unit emits pump light LP1 in a direction toward the holding surface. Four reference sample parts are provided on a part of the holding surface. The reference sample parts each radiate a terahertz wave in response to irradiation with the pump light from the pump light irradiating unit. A terahertz wave detecting unit detects the terahertz wave radiated from each reference sample part. A stage driving mechanism is a displacement mechanism that displaces an optical path of the pump light relative to the holding surface by moving the movable stage.

### BACKGROUND OF THE INVENTION

1. Field of the Invention

The present invention relates to a testing technique of detecting an electromagnetic wave radiated from a test object, more specifically, to a technique relating to a test for abnormality in a measuring system.

2. Description of the Background Art

According to a known technique of testing a test object such as a semiconductor device or a photo device, the test object is irradiated with light of a specific wavelength to generate an electromagnetic wave (that is mainly a terahertz wave). Then, this electromagnetic wave is detected (see Japanese patent application laid-open Nos. 2013-019861 and 2013-174477, for example). According to this testing technique, the test object can be tested in a non-contact and non-destructive manner in terms of the characteristics thereof of a defect therein, for example.

In a conventional testing apparatus, however, the occurrence of abnormality in a measuring system (such as deviation of the optical axis of an optical system) for example due to temporal change or change in ambient temperature causes the risk of difficulty in detecting an electromagnetic wave. Thus, if a terahertz wave from the test object cannot be detected normally, it cannot be determined easily whether this failure to detect a terahertz wave normally is due to abnormality in the measuring system or a defect occurring on the side of the test object.

### SUMMARY OF THE INVENTION

A first aspect is intended for a testing apparatus that tests a test object. The testing apparatus includes: a holder having a holding surface on which the test object is held; a first irradiating unit that emits pump light in a direction toward the holding surface; one or more reference sample parts provided on a part of the holding surface, the one or more reference sample parts each radiating an electromagnetic wave in response to irradiation with the pump light from the first irradiating unit; a detecting unit that detects the electromagnetic wave; and a displacement mechanism that displaces an optical path of the pump light relative to the holding surface.

According to the first aspect, a test is conducted to determine whether the electromagnetic wave can be detected using the reference sample part. As a result, abnormality in a measuring system such as an optical system can be detected. Additionally, by the presence of the reference sample part on the holding surface, the optical path of the pump light is changed so as to lead to the reference sample part, thereby allowing a test of the measuring system.

According to a second aspect, the testing apparatus according to the first aspect further includes a second irradiating unit that irradiates the detecting unit with probe light. The detecting unit includes a detector that generates a current responsive to the electric field intensity of the electromagnetic wave incident on the detector in response to irradiation with the probe light from the second irradiating unit.

According to the second aspect, an optical system that guides the probe light toward the detector can be tested.

According to a third aspect, the testing apparatus according to the first or second aspect further includes a height position measuring unit provided adjacent to the holding surface relative to the holder. The height position measuring unit measures the height position of the each reference sample part provided in three or more different places on the holding surface.

According to the third aspect, the height positions of the reference sample parts provided in the three or more different places on the holding surface are measured. This allows measurement of the parallelism of the holding surface.

According to a fourth aspect, in the testing apparatus according to the any one of the first to third aspects, the one or more reference sample parts contain a semiconductor bulk crystal including at least one of indium arsenide, indium phosphide, gallium arsenide, cadmium telluride, and monocrystalline silicon.

According to the fourth aspect, the semiconductor bulk crystal including indium arsenide, indium phosphide, gallium arsenide, cadmium telluride, or monocrystalline silicon is used to form the reference sample part. This allows the reference sample part in a non-biased state to generate an electromagnetic wave.

A fifth aspect is a method of testing a test object. The method includes the steps of: (a) holding a test object on a holding surface of a holder; (b) emitting pump light toward an reference sample part provided on a part of the holding surface; (c) detecting an electromagnetic wave radiated from the reference sample part in response to irradiation with the pump light; and (d) displacing an optical path of the pump light relative to the holding surface.

It is therefore an object of the present invention to provide a technique capable of detecting abnormality easily in a measuring system that measures an electromagnetic wave.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view showing an outline of a testing apparatus according to a preferred embodiment;

FIG. 2 shows an outline of the structure of a terahertz wave measuring system according to the preferred embodiment;

FIG. 3 is a plan view showing an outline of a solar cell held on a voltage application table of a sample table according to the preferred embodiment;

FIG. 4 is a block diagram showing electrical connections between a controller and different elements of the testing apparatus according to the preferred embodiment;

FIG. 5 is a flowchart showing a flow of a process of testing an optical system according to the preferred embodiment; and

FIG. 6 is a flowchart showing a flow of a process of testing a stage parallelism according to the preferred embodiment.

### DESCRIPTION OF THE PREFERRED EMBODIMENTS

A preferred embodiment according to the present invention will now be described with reference to the accompanying drawings. Components described in the preferred embodiments are merely illustrative, and there is no intention to limit the scope of the present invention thereto. In the drawings, the dimensions of components and the number of components are shown in exaggeration or in simplified form, as appropriate, for the sake of easier understanding.

### 1. Preferred Embodiment

FIG. 1 is a side view showing an outline of a testing apparatus 100 according to a preferred embodiment. The testing apparatus 100 includes a mount 1 for the apparatus, a terahertz wave measuring system 2, a movable stage 3, a sample table 4, and a controller 7.

To clearly show a relationship in terms of direction among FIG. 1 and subsequent drawings, a left-handed XYZ orthogonal coordinate system is given to these drawings, where appropriate. This coordinate system defines a Z-axis direction as a vertical direction and an XY plane as a horizontal plane. The horizontal plane (XY plane) is parallel to a surface of the movable stage 3 and the vertical direction (Z-axis direction) includes an upward direction and a downward direction vertical to the horizontal plane.

The terahertz wave measuring system 2 emits pulsed light (pump light LP11) toward a test object that is a semiconductor device or a photo device. Then, the terahertz wave measuring system 2 detects an electromagnetic wave (a terahertz wave of a frequency mainly from 0.1 to 30 THz) radiated from the test object in response to the irradiation with this pulsed light.

The semiconductor device is an electronic device such as a transistor, an integrated circuit (an IC or an LSI), a resistor, or a capacitor made of semiconductor. The photo device is an image sensor such as a CMOS sensor or a CCD sensor or an electronic device that uses the photoelectric effect of semiconductor such as a solar cell or an LED. In the following description, a solar cell 9 as a photo device is described as an example of the test object. The structure of the terahertz wave measuring system 2 is described in detail later.

The movable stage 3 is moved in each of the X-axis direction, the Y-axis direction, and the Z-axis direction by a stage driving mechanism 31 (displacement mechanism). The stage driving mechanism 31 includes an X-axis direction moving mechanism that moves the movable stage 3 in the X direction, a Y-axis direction moving mechanism that moves the movable stage 3 in the Y direction, and an elevating mechanism that moves the movable stage 3 in the Z direction.

The sample table 4 is attached to the upper surface (holding surface 300) of the movable stage 3. The sample table 4 includes a voltage application table 41 and an electrode pin unit 43.

The voltage application table 41 is made of a material having high electric conductivity such as copper. The voltage application table 41 has a surface plated with gold. The surface of the voltage application table 41 is provided with a plurality of suction holes. The suction holes are connected to a suction pump. By driving this suction pump, the rear surface of the solar cell 9 is attached under suction to the voltage application table 41. In this way, the solar cell 9 is fixed to the sample table 4. The surface of the voltage application table 41 may be provided with a plurality of suction grooves and the aforementioned suction holes may be formed in these suction grooves. In this case, the solar cell 9 is sucked along these suction grooves, so that the solar cell 9 can be fixed firmly.

As the movable stage 3 moves in the X-axis direction, the Y-axis direction, and the Z-axis direction, the solar cell 9 held on the sample table 4 on the movable stage 3 moves in each of the X-axis direction, the Y-axis direction, and the Z-axis direction. The movable stage 3 is an example of a holder that holds the solar cell 9 through the voltage application table 41.

The electrode pin unit 43 includes a plurality of conductive electrode pins 431 and a conductive electrode bar 432 that supports these electrode pins 431.

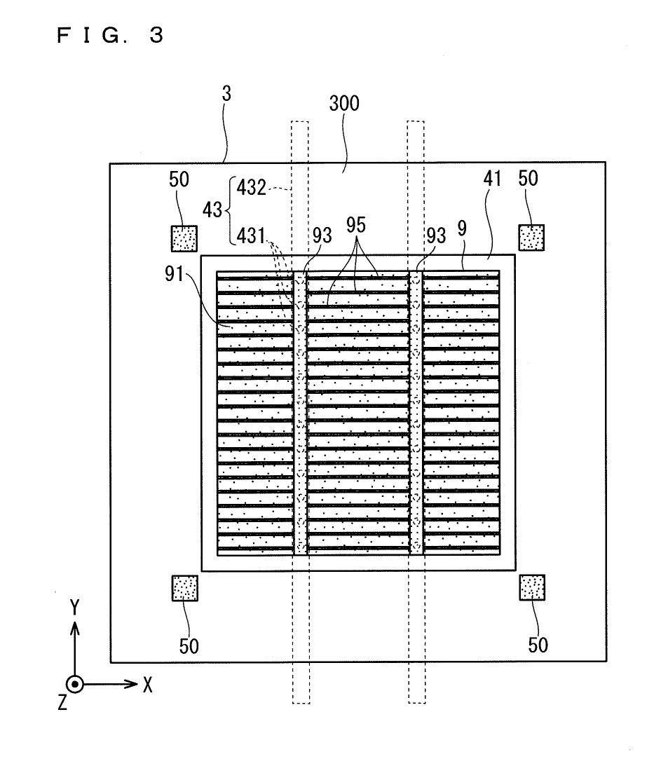

The electrode bar 432 holds the bar-like electrode pins 431 in such a manner that the electrode pins 431 are separated at given intervals in the Y-axis direction and the electrode pins 431 are each placed in a standing posture in the Z direction. In this preferred embodiment, the electrode bar 432 holds the electrode pins 431 in such a manner as to extend along a bus-bar electrode 93 as a front surface side electrode of the solar cell 9 held on the sample table 4 (see FIG. 3).

The sample table 4 makes the voltage application table 41 contact a rear surface side electrode of the solar cell 9 and makes the electrode pins 431 contact the front surface side electrode (here, bus-bar electrode 93 described later) of the solar cell 9. The voltage application table 41 and the electrode pin unit 43 are electrically connected to each other and apply a voltage between the front surface side electrode and the rear surface side electrode of the solar cell 9.

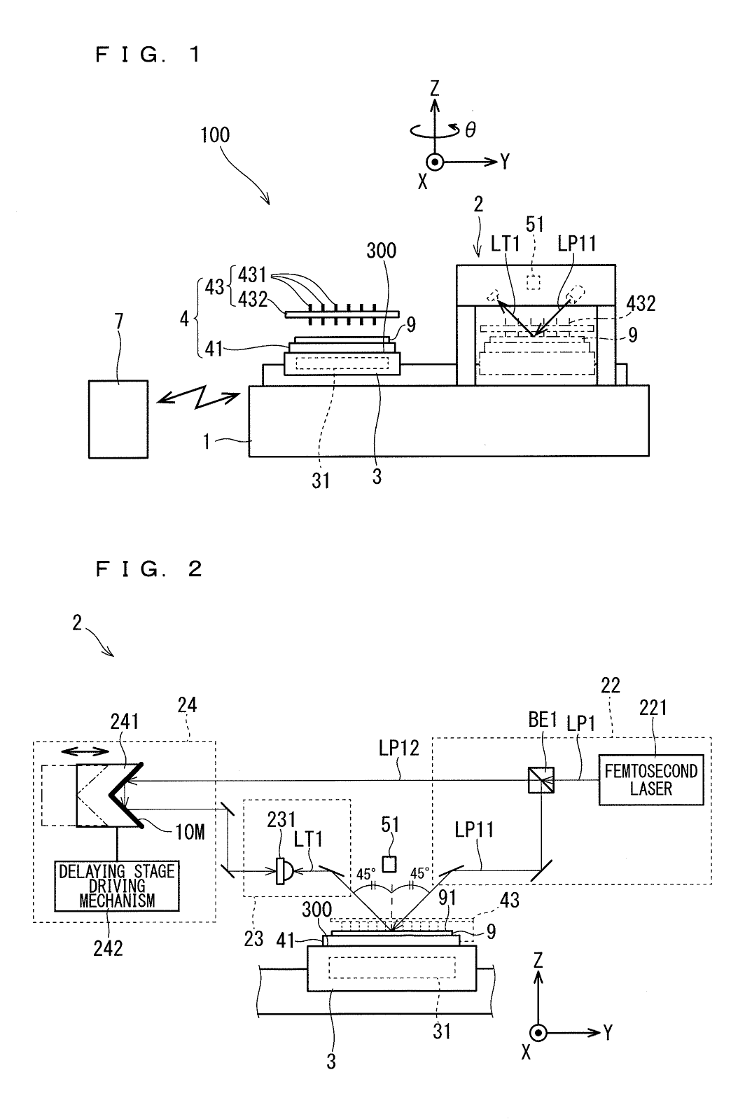

FIG. 2 shows an outline of the structure of the terahertz wave measuring system s according to the preferred embodiment. The terahertz wave measuring system 2 includes a pump light irradiating unit 22, a terahertz wave detecting unit 23, and a delaying unit 24.

The pump light irradiating unit 22 includes a femtosecond laser 221. The femtosecond laser 221 oscillates pulsed light LP1 of a wavelength including a visible light region from 360 nm (nanometers) to 1.5 μm (micrometers), for example. As an example, the pulsed light oscillated by and emitted from the femtosecond laser 221 is linearly polarized pulsed light of a central wavelength around 800 nm, a cycle from several kHz to several hundreds of MHz, and a pulse width from about 10 to about 150 femtoseconds. The pulsed light oscillated by the femtosecond laser 221 may certainly be pulsed light of a different wavelength region (a wavelength of visible light such a blue wavelength (from 450 to 495 nm) or a green wavelength (from 495 to 570 nm), for example).

The pulsed light LP1 oscillated by and emitted from the femtosecond laser 221 is split into two by a beam splitter BE1. One pulsed light (pump light LP11) resulting from the splitting is emitted toward the holding surface 300 of the movable stage 3 through a designated optical system.

Regarding irradiation of the solar cell 9 with the pump light LP11, the pump light irradiating unit 22 irradiates the solar cell 9 with the pump light LP11 from the direction of a light-receiving surface 91 of the solar cell 9. Further, the pump light irradiating unit 22 irradiates the solar cell 9 with the pump light LP11 in such a manner that the pump light LP11 is incident on the light-receiving surface 91 of the solar cell 9 while the optical axis of the pump light LP11 is diagonal to the light-receiving surface 91. In this preferred embodiment, an angle of the irradiation is adjusted in such a manner that the pump light LP11 is incident on the light-receiving surface 91 at an angle of 45 degrees. However, this is not the only incident angle but the incident angle can be changed appropriately in a range from 0 to 90 degrees.

A photo device such as the solar cell 9 has a pn junction where a p-type semiconductor and an n-type semiconductor are joined, for example. In a region near the pn junction, electrons and holes diffuse to be coupled to each other, thereby generating a diffusion current. As a result, a depletion layer nearly empty of electrons and holes is formed in the region near the pn junction. In this region, force of pulling electrons and holes back into an n-type region and a p-type region respectively is generated to form an electric field (internal electric field) inside the photo device.

If the pn junction is irradiated with light having energy exceeding that of a forbidden band, free electrons and free holes are generated at the pn junction. The free electrons are moved toward the n-type semiconductor and the remaining free holes are moved toward the p-type semiconductor by the internal electric field. In the photo device, a resultant current is extracted to the outside through an electrode attached to each of the n-type semiconductor and the p-type semiconductor. In the case of a solar cell, for example, movement of free electrons and that of free holes generated in response to irradiation of the depletion layer near the pn junction with light are used as a DC current.

According to Maxwell's equations, if change in a current is generated, an electromagnetic wave of an intensity proportionate to the time differentiation of this current is generated. Specifically, by irradiating a region where photoexcited carrier is generated such as a depletion layer with pulsed light, a photocurrent is generated and then disappears instantaneously. In proportion to the time differentiation of this photocurrent generated instantaneously, an electromagnetic wave (terahertz wave LT1) is generated.

As shown in FIG. 2, the other pulsed light resulting from the splitting by the beam splitter BE1 passes through the delaying unit 24 as probe light LP12 and then enters a terahertz wave detector 231 of the terahertz wave detecting unit 23. The terahertz wave LT1 generated in response to irradiation with the pump light LP11 is collected appropriately for example through a parabolic mirror not shown in the drawings. Then, the collected terahertz wave LT1 enters the terahertz wave detector 231.

The terahertz wave detector 231 for example includes a photoconducting switch as an electromagnetic detecting element. If the terahertz wave detector 231 is irradiated with the probe light LP12 while the terahertz wave LT1 is incident on the terahertz wave detector 231, a current responsive to the electric field intensity of the terahertz wave LT1 is generated instantaneously at the photoconducting switch. This current responsive to the electric field intensity is passed through an I/V converting circuit, an A/D converting circuit, etc. to be converted to a digital quantity. In this way, the terahertz wave detecting unit 23 detects the electric field intensity of the terahertz wave LT1 radiated from the solar cell 9 in response to irradiation with the probe light LP12. An element different from the photoconducting switch such as a non-linear optical crystal is applicable as the terahertz wave detector 231. Alternatively, the electric field intensity of a terahertz wave may be detected using a Schottky barrier diode.

The delaying unit 24 is an optical unit that changes time of arrival of the probe light LP12 at the terahertz wave detector 231 continuously. The delaying unit 24 includes a delaying stage 241 that moves linearly along an incident direction of the probe light LP12 and a delaying stage driving mechanism 242 that moves the delaying stage 241. The delaying stage 241 includes a return mirror 10M that makes the probe light LP12 return to the incident direction of the probe light LP12. The delaying stage driving mechanism 242 moves the delaying stage 241 parallel to the incident direction of the probe light LP12 under control by the controller 7. In response to the parallel movement of the delaying stage 241, an optical path length of the probe light LP12 from the beam splitter BE1 to the terahertz wave detector 231 is changed continuously.

The delaying stage 241 changes a difference (phase difference) between time when the terahertz wave LT1 arrives at the terahertz wave detector 231 and time when the probe light LP12 arrives at the terahertz wave detector 231. More specifically, the delaying stage 241 changes the optical path length of the probe light LP12, thereby delaying timing of detection of the electric field intensity of the terahertz wave LT1 (detection timing or sampling timing) at the terahertz wave detector 231.

Time of arrival of the probe light LP12 at the terahertz wave detector 231 can be changed by a structure different from the delaying stage 241. More specifically, the arrival time can be changed by using electro-optical effect. Specifically, an electro-optical element that is changed in refractive index by changing a voltage to be applied is applicable as a delaying element. For example, the electro-optical element disclosed in Japanese patent application laid-open No. 2009-175127 can be used.

Instead of changing the optical path length of the probe light LP12, an optical path length of the pump light LP11 traveling toward the solar cell 9 or that of the terahertz wave LT1 radiated from the solar cell 9 may be changed. In either case, time of arrival of the terahertz wave LT1 at the terahertz wave detector 231 can be shifted from time of arrival of the probe light LP12 at the terahertz wave detector 231. Specifically, timing of detection of the terahertz wave LT1 at the terahertz wave detector 231 can be put forward or delayed.

In this preferred embodiment, one pump light irradiating unit 22 functions both as an irradiating unit (first irradiating unit) that emits the pump light LP11 toward the holding surface 300 and as an irradiating unit (second irradiating unit) that emits the probe light LP12 toward the terahertz wave detecting unit 23. Alternatively, the pump light LP11 and the probe light LP12 may be emitted from respective irradiating units. For example, a femtosecond laser 221 that emits the pump light LP11 and a femtosecond laser 221 that emits the probe light LP12 may be provided independently. Further, the delaying unit 24 may be provided in either of optical paths of these femtosecond lasers 221.

FIG. 3 is a plan view showing an outline of the solar cell 9 held on the voltage application table 41 of the sample table 4 according to the preferred embodiment. The front surface side electrode formed on the light-receiving surface 91 of the solar cell 9 is formed of two bus-bar electrodes 93 like elongated rectangular plates extending in one direction and a large number of finger electrodes 95 like thin plates extending so as to be perpendicular to both of these bus-bar electrodes 93. The bus-bar electrodes 93 are wider than the finger electrodes 95.

The solar cell 9 is placed on the sample table 4 in such a manner that the longitudinal direction of the bus-bar electrodes 93 agrees with the Y-axis direction in advance. As shown in FIG. 3, during application of a voltage to the solar cell 9, the electrode pins 431 arranged at given intervals in the Y-axis direction abut on each of the bus-bar electrodes 93.

For measurement about a terahertz wave from the solar cell 9, a bias voltage or a reverse bias voltage may be applied to the solar cell 9 through the voltage application table 41 and the electrode pin unit 43 of the sample table 4. For example, applying the reverse bias voltage can extend the depletion layer in the solar cell 9. This can increase the intensity of the terahertz wave LT1 radiated from the solar cell 9. The front surface side electrode and the rear surface side electrode of the solar cell 9 may be shorted by forming a short circuit connection between the voltage application table 41 and the electrode bar 432. Even on the occurrence of the short circuit, the intensity of the terahertz wave LT1 radiated from the solar cell 9 can still be increased.

As shown in FIG. 1, the solar cell 9 is irradiated with the pump light LP11 traveling in the Y-axis direction (in the example of FIG. 1, from the +Y side toward the −Y side). The terahertz wave detector 231 detects the terahertz wave LT1 radiated in the Y-axis direction (in the example of FIG. 1, from the +Y side toward the −Y side). In this way, in this preferred embodiment, a direction where the solar cell 9 is irradiated with the pump light LP11 and a direction where the solar cell 9 radiates the terahertz wave LT1 to be detected become the same as a direction where the electrode pins 431 are arranged at given intervals (specifically, Y-axis direction). This can make it unlikely that the pump light LP11 as probe light will be blocked by the electrode pins 431 or the generated terahertz wave LT1 will be blocked by the electrode pins 431.

As shown in FIG. 3, a plurality of reference sample parts 50 is provided on a part of the holding surface 300 of the movable stage 3. In this preferred embodiment, the reference sample parts 50 are provided in different places on the substantially rectangular holding surface 300. In this preferred embodiment, the substantially rectangular voltage application table 41 is placed on the center of the substantially rectangular holding surface 300. The reference sample parts 50 are provided in their places outside the voltage application table 41 and near the four corners of the voltage application table 41 on the holding surface 300. In this example, all the reference sample parts 50 are placed on the diagonal lines of the voltage application table 41 or the holding surface 300.

Each reference sample part 50 may be fixed to the upper surface of the holding surface 300 of the movable stage 3 or may be buried in the movable stage 3 while a surface of the reference sample part 50 is exposed. As long as a terahertz wave radiated from each reference sample part 50 can be detected by the terahertz wave detecting unit 23, each reference sample part 50 may be provided on the holding surface 300 in any way.

Each reference sample part 50 is configured to radiate a terahertz wave as an electromagnetic wave in response to irradiation with the pump light LP11. It is preferable that each reference sample part 50 be configured in such a manner that the reference sample part 50 can still radiate a terahertz wave even if the reference sample part 50 is in a non-biased state in the absence of application of a bias voltage.

As an example, each reference sample part 50 is formed of a semiconductor bulk crystal. Specific examples of the semiconductor material include indium arsenide (InAs), indium phosphide (InP), gallium arsenide (GaAs), cadmium telluride (CdTe), and monocrystalline silicon (Si). Even if the bulk crystal formed of these semiconductor materials is in a non-biased state in the absence of application of a bias voltage, this bulk crystal can still radiate a terahertz wave favorably in response to irradiation with the pump light LP11.

Each reference sample part 50 is a plate-like rectangular member (25 mm square, for example) having a planarized surface. By planarizing the surface, the height position of this surface can be measured accurately by a substrate thickness measuring instrument 51 described later.

Not all the reference sample parts 50 are required to have planarized surfaces. As long as a terahertz wave radiated from each reference sample part 50 can be detected by the terahertz wave detecting unit 23, the shape of each reference sample part 50 can be determined in any way.

As shown in FIG. 2, the substrate thickness measuring instrument 51 is arranged adjacent to the holding surface 300 of the movable stage 3 (specifically, +Z side). The substrate thickness measuring instrument 51 measures the thickness of the solar cell 9 as a test object. The substrate thickness measuring instrument 51 is formed of a laser light emitting part and an optical sensor not shown in the drawings. The laser emitting part emits laser light toward a surface of a measurement object at a given angle to the surface. The optical sensor is for example formed of a line sensor and receives the laser light reflected off the surface of the measurement object. A position of incidence of the reflected laser light on the optical sensor is displaced in a manner that depends on the height position of the surface of the measurement object. The substrate thickness measuring instrument 51 measures the height position of the surface of the measurement object by specifying the incident position of the laser light using the optical sensor. Specifically, the substrate thickness measuring instrument 51 is configured as an optical measuring instrument that measures the height position of a test object in a non-contact manner. The thickness of the test object can be measured using a difference between the height position of the test object and the height position of the reference sample part 50 (or holding surface 300).

The substrate thickness measuring instrument 51 may be configured to make measurement employing a system other than an optical system. For example, the substrate thickness measuring instrument 51 may detect the height position of the surface of the test object by emitting an ultrasonic wave toward the test object and measuring a period of time to elapse before the ultrasonic wave reflected off the test object is detected by a detector.

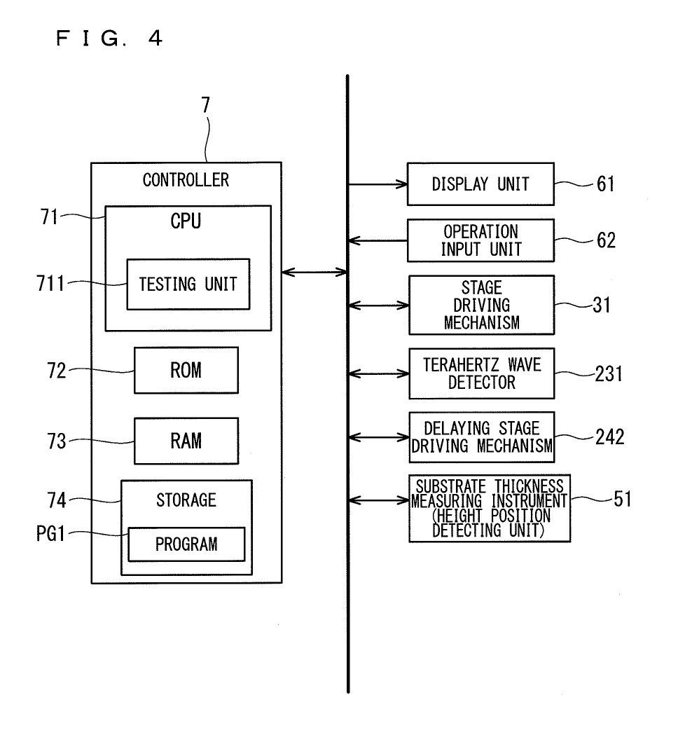

FIG. 4 is a block diagram showing electrical connections between the controller 7 and different elements of the testing apparatus 100 according to the preferred embodiment. The controller 7 includes a CPU 71 as a computing unit, a read-only ROM 72, a RAM 73 mainly used as a working area for the CPU 71, and a storage 74 as a nonvolatile recording medium. The controller 7 is connected for example through a bus line, a network line, or a serial communication line to each of the elements of the testing apparatus 100 including a display unit 61, an operation input unit 62, the stage driving mechanism 31, the terahertz wave detector 231, the delaying stage driving mechanism 242, and the substrate thickness measuring instrument 51. The controller 7 controls operations of these elements and receives data from these elements.

The CPU 71 reads a program PG1 stored in the storage 74 and executes the read program PG1, thereby performing arithmetic processing on data of various types stored in the RAM 73 or the storage 74. As described above, the controller 7 includes the CPU 71, the ROM 72, the RAM 73, and the storage 74, and is configured as a general computer.

A testing unit 711 shown in FIG. 4 is a functional module realized in response to operation of the CPU 71 according to the program PG1 stored in the storage 74. As described later, the testing unit 711 irradiates the reference sample parts 50 with the pump light LP11 and detects the resultant radiated terahertz wave LT1, thereby performing a testing process of conducting a test for abnormality in a measuring system.

The display unit 61 is formed of a liquid crystal display, for example, and presents information of various types to an operator. The operation input unit 62 is configured as various types of input devices including a mouse and a keyboard. The operation input unit 62 accepts operation by the operator to give a command to the controller 7. The display unit 61 may have a function as a touch panel. In this case, the display unit 61 may include some or all of the functions of the operation input unit 62.

<Flow of Operation of Testing Apparatus>

A flow of the operation of the testing apparatus 100 is described next.

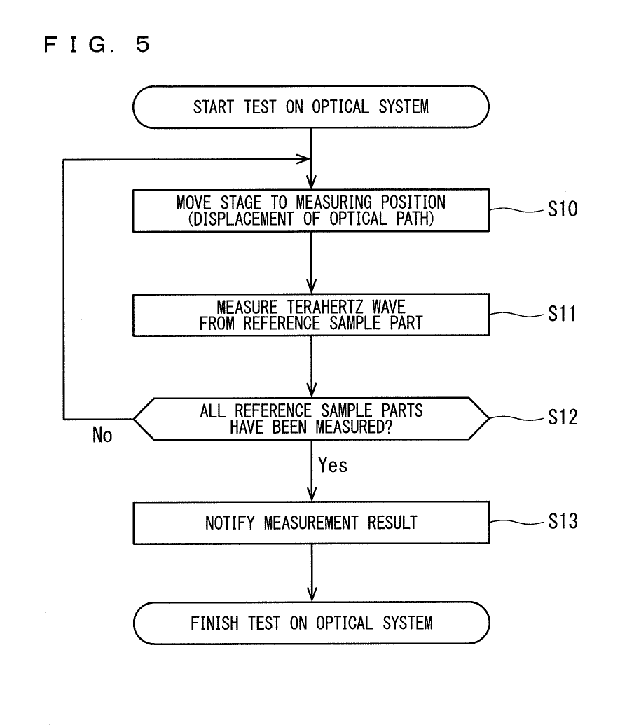

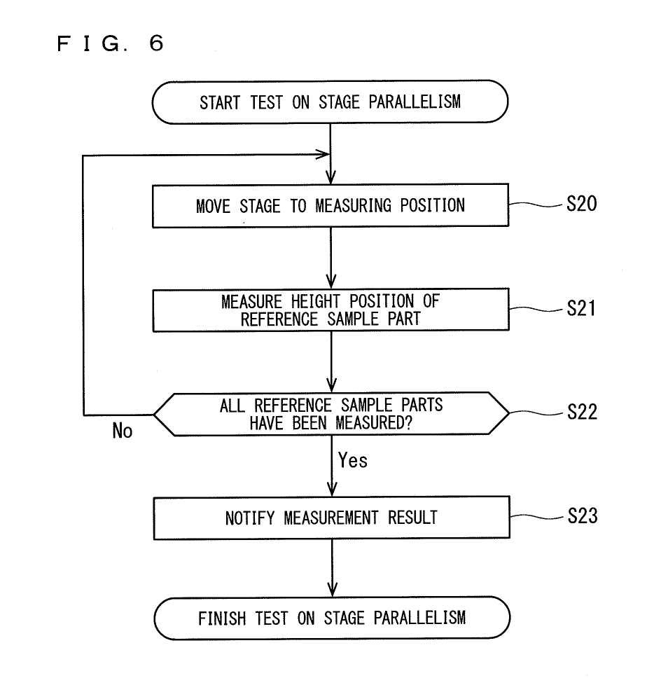

FIG. 5 is a flowchart showing a flow of a process of testing an optical system according to the preferred embodiment. FIG. 6 is a flowchart showing a flow of a process of testing a stage parallelism according to the preferred embodiment. Unless otherwise specified, the testing processes shown in FIGS. 5 and 6 are performed under control by the testing unit 711.

### Process of Testing Optical System

The process of testing an optical system shown in FIG. 5 is described first. This testing process is to conduct a test about abnormality in the optical system by detecting a terahertz wave from the reference sample part 50.

More specifically, as shown in FIG. 5, the testing unit 711 moves the movable stage 3 using the movable stage driving mechanism 31 in such a manner that the pump light LP11 from the pump light irradiating unit 22 is incident on any one of the four reference sample parts 50 (step S10). This corresponds to a step of displacing an optical path of the pump light LP11 relative to the holding surface 300 of the movable stage 3.

Next, the testing unit 711 makes the pump light irradiating unit 22 emit the pump light LP11 and irradiates the reference sample part 50 with the emitted pump light LP11. Then, the testing unit 711 detects a terahertz wave radiated from this reference sample part 50 (step S11). At this time, the testing unit 711 may sample the electric field intensities of the radiated terahertz wave in each different phase by driving the delaying stage 241 of the delaying unit 24, thereby restoring the temporal waveform of the terahertz wave. Alternatively, the delaying stage 241 can be fixed during detection of the terahertz wave.

Next, the testing unit 711 determines whether terahertz waves from all the reference sample parts 50 have been measured (step S12). If there is an reference sample part 50 not subjected to the measurement (NO of step S12), the testing unit 711 returns to step S10 and performs the processes in steps S10 and S11 on the reference sample part 50 not subjected to the measurement. If the measurement about all the reference sample parts 50 is finished (YES of step S12), the testing unit 711 notifies a result of the measurement to the outside (step S13). Not all the reference sample parts 50 are required to be subjected to the measurement. For example, the testing unit 711 may be configured to measure a terahertz wave from only one reference sample part 50. Alternatively, the testing unit 711 may be configured to measure a terahertz wave from an reference sample part 50 identified out of the plurality of reference sample parts 50 by an operator.

As an example of the notification in step S13, the temporal waveform or electric field intensity of the terahertz wave radiated from each reference sample part 50 and measured in step S11 may be displayed on the display unit 61. This allows the operator to check abnormality in an optical system based on the measurement result about the terahertz wave displayed on the display unit 61. If the electric field intensity of the terahertz wave is not detected or the intensity of the electric field is low, for example, abnormality such as deviation of an optical axis can be assumed to occur in the optical system of the pump light irradiating unit 22 or the optical system of the terahertz wave detecting unit 23, etc. If abnormality is recognized in the restored temporal waveform, this abnormality can be assumed to result from abnormality in the delaying unit 24.

The testing unit 711 may be configured to determine the presence or absence of abnormality based on the measurement result about the terahertz wave and notify a result of the determination to the outside. For example, a result of measurement about a terahertz wave from each reference sample part 50 may be obtained and stored as reference data for example into the storage 74 in advance. The testing unit 711 may compare a measurement result newly obtained in step S11 and the reference data in the storage 74. Then, the testing unit 711 may determine the presence or absence of abnormality based on a degree of a difference between this measurement result and the reference data.

An average of the electric field intensities of terahertz waves measured about the plurality of reference sample parts 50 may be used as the reference data. In this case, the testing unit 711 may determine the presence or absence of abnormality based on comparison between this reference data and the electric field intensity of a terahertz wave radiated from one reference sample part 50 or an average of the electric field intensities of terahertz waves radiated from two or more reference sample parts 50.

A result of the determination by the testing unit 711 may be notified to the outside as a measurement result in step S13.

As described above, by the presence of the reference sample part 50 provided on the holding surface 300 of the movable stage 3, a test can be conducted for abnormality in the optical system of the testing apparatus 100 itself.

By the presence of the reference sample part 50 provided on the holding surface 300 of the movable stage 3, a test can be conducted for abnormality in the optical system only by moving the movable stage 3.

Employing the reference sample part 50 configured to radiate a terahertz wave even in a non-biased state can make a circuit for voltage application unnecessary. As a result, the structure of the movable stage 3 can be simplified.

### Process of Testing Stage Parallelism

The process of testing a stage parallelism is described next. In this testing process, the substrate thickness measuring instrument 51 measures the height position of each reference sample parts 50 individually. The height position of the reference sample part 50 corresponds to the height position of the holding surface 300 of the movable stage 3. Thus, by measuring the height positions of the reference sample parts 50 located in four places, the parallelism of the holding surface 300 (a degree of inclination from a reference plane (X-Y plane, for example)) can be tested.

More specifically, as shown in FIG. 6, the movable stage 3 is moved to a measuring position so that the substrate thickness measuring instrument 51 can measure the height position of a surface of any one of the four reference sample parts 50 (step S20). Then, the substrate thickness measuring instrument 51 measures the height position of the reference sample part 50 (step S21). Information about the measured height position is stored in the storage 74 or the RAM 73, for example.

Next, the testing unit 711 determines whether the height positions of all the four reference sample parts 50 have been measured (step S22). If there is an reference sample part 50 not subjected to the measurement (NO of step S22), the testing unit 711 returns to step S20 and performs the processes in steps S20 and S21 on the reference sample part 50 not subjected to the measurement. If the measurement about all the reference sample parts 50 is finished (YES of step S22), the testing unit 711 notifies a result of the measurement to the outside (step S23).

As an example of the notification in step S23, the height position of the surface of each reference sample part 50 measured in step S21 is displayed on the display unit 61. This allows an operator to test the parallelism of the holding surface 300 of the movable stage 3 to the reference plane based on the height position displayed on the display unit 61.

The testing unit 711 may be configured to determine the presence or absence of abnormality based on the measurement result about the height position and notify a result of the measurement to the outside. For example, the testing unit 711 may determine the presence of abnormality if the height position of any one of the four reference sample parts 50 is higher than or lower than a specified reference value.

As described above, the parallelism of the holding surface 300 can be measured by measuring the height position of each reference sample part 50. By using this measurement, the height position of the holding surface 300 can be adjusted appropriately. Thus, the terahertz wave LT1 radiated from each part of a test object can be detected favorably.

The height position of each reference sample part 50 is measured using the substrate thickness measuring instrument 51 used to measure the thickness of a test object such as the solar cell 9. Thus, the parallelism of the holding surface 300 can be measured without the need of preparing an additional instrument.

In this preferred embodiment, the height positions of all the four reference sample parts 50 are measured. Meanwhile, the parallelism of the movable stage 3 can be measured by measuring the height positions of any three of the reference sample parts 50 or more.

In this preferred embodiment, the reference sample parts 50 are provided in four places on the holding surface 300. Meanwhile, the parallelism of the movable stage 3 can be measured by providing the reference sample parts 50 in three or more places. Alternatively, the reference sample part 50 may be provided only in one place on the holding surface 300. It is difficult to measure the parallelism of the movable stage 3 only by measuring the height position of the reference sample part 50 in one place. However, the test on the optical system of the testing apparatus 100 shown in FIG. 5 can still be conducted by measuring a terahertz wave radiated from this reference sample part 50.

While the invention has been described in detail, the foregoing description is in all aspects illustrative and not restrictive. It is therefore understood that numerous modifications and variations can be devised without departing from the scope of the invention.

What is claimed is:

1. A testing apparatus that tests a test object comprising:
a holder having a holding surface on which said test object is held;
a first irradiating unit that emits pump light in a direction toward said holding surface;
one or more reference sample parts provided on a part of said holding surface, said one or more reference sample parts each radiating an electromagnetic wave in response to irradiation with said pump light from said first irradiating unit;
a detecting unit that detects said electromagnetic wave; and
a displacement mechanism that displaces an optical path of said pump light relative to said holding surface.

2. The testing apparatus according to claim 1, further comprising a second irradiating unit that irradiates said detecting unit with probe light,
wherein said detecting unit includes a detector that generates a current responsive to the electric field intensity of said electromagnetic wave incident on said detector in response to irradiation with said probe light from said second irradiating unit.

3. The testing apparatus according to claim 1, further comprising a height position measuring unit provided adjacent to said holding surface relative to said holder, said height position measuring unit measuring the height positions of said reference sample parts each provided in three or more different places on said holding surface.

4. The testing apparatus according to claim 1, wherein said one or more reference sample parts contain a semiconductor bulk crystal including at least one of indium arsenide, indium phosphide, gallium arsenide, cadmium telluride, and monocrystalline silicon.

5. A method of testing a test object comprising the steps of:
(a) holding a test object on a holding surface of a holder;
(b) emitting pump light toward a reference sample part provided on a part of said holding surface;
(c) detecting an electromagnetic wave radiated from said reference sample part in response to irradiation with said pump light; and
(d) displacing an optical path of said pump light relative to said holding surface.
